(19) United States
(12) Patent Application Publication
(10) Pub. No.: US 2025/0244254 A1
(43) Pub. Date: Jul. 31, 2025

(54) INSPECTION APPARATUS AND INSPECTION METHOD

(71) Applicant: Lasertec Corporation, Yokohama (JP)

(72) Inventor: Airi KOBAYASHI, Yokohama (JP)

(21) Appl. No.: 19/013,875

(22) Filed: Jan. 8, 2025

(30) Foreign Application Priority Data
Jan. 29, 2024 (JP) 2024-010661
Jul. 19, 2024 (JP) 2024-115436

(51) Int. Cl. G01N 21/88

(52) U.S. Cl. CPC G01N 21/8806; G01N 21/8851; G01N 2021/8825

(57) ABSTRACT

An inspection apparatus according to the present disclosure includes a first optical system that illuminates a film with first light transmitted through the film and receives first observation light from a first surface side of the film, a second optical system that illuminates the film from the first surface side with second light reflected from the first surface of the film and receives second observation light from the first surface side, and a determination unit that determines whether a position of a defect of the film is a defect above the first surface of the film or a defect below the first surface based on a combination of an observation result of bright-field observation in the first optical system and an observation result of dark-field observation in the second optical system.

### INCORPORATION BY REFERENCE

This application is based upon and claims the benefit of priority from Japanese patent application No. 2024-010661, filed on Jan. 29, 2024, and Japanese patent application No. 2024-115436, filed on Jul. 19, 2024, the disclosure of which is incorporated herein in its entirety by reference for all purposes.

### BACKGROUND

The present disclosure relates to an inspection apparatus and an inspection method.

Japanese Unexamined Patent Application Publication No. H06-258241 proposes an inspection method to be performed by a dark-field illumination system that enables a foreign matter on a pellicle to be discriminated as a foreign matter on the front surface of the pellicle or a foreign matter on the rear surface.

### SUMMARY

It is desired to determine whether a defect of a film such as a pellicle is a defect on the front surface of the film or a defect on the rear surface with higher accuracy.

The present disclosure has been made to solve the above-described problem and has an object to provide an inspection apparatus and an inspection method that enable a defect of a film to be determined with high accuracy.

An inspection apparatus according to the present disclosure includes: a first optical system configured to illuminate a film with first light transmitted through the film and receive first observation light from a first surface side of the film; a second optical system configured to illuminate the film from the first surface side with second light reflected from the first surface of the film and receive second observation light from the first surface side; and a determination unit configured to determine whether a position of a defect of the film, when the first surface side in a thickness direction of the film is located above and a second surface side on an opposite side of the first surface is located below, is the defect above the first surface of the film or the defect below the first surface based on a combination of an observation result of bright-field observation in the first optical system and an observation result of dark-field observation in the second optical system.

In the above-described inspection apparatus, the determination unit may determine that the defect is the defect above the first surface in a case in which the defect is detected both in the observation result in the first optical system and the observation result in the second optical system, and may determine that the defect is the defect below the first surface in a case in which the defect is detected in the observation result in the first optical system and in which the defect is not detected in the observation result in the second optical system.

In the above-described inspection apparatus, the determination unit may determine that the defect is the defect due to a foreign matter on the first surface in a case in which the defect is detected both in the observation result in the first optical system and the observation result in the second optical system, and may determine that the defect is the defect due to a foreign matter on the second surface in a case in which the defect is detected in the observation result in the first optical system and in which the defect is not detected in the observation result in the second optical system.

In the above-described inspection apparatus, the first optical system may make an optical axis of the first light perpendicular to the first surface, the second optical system may use off-axis illumination in which an optical axis of the second light is inclined with respect to the first surface, and an objective lens configured to receive the second observation light in the second optical system may be common to the objective lens configured to receive the first observation light in the first optical system.

In the above-described inspection apparatus, the first optical system may illuminate the film from the first surface side with the first light, and the objective lens may focus the first light in the first optical system on the film.

In the above-described inspection apparatus, the first light in the first optical system may include a wavelength equal to or larger than 600 nm and equal to or smaller than 750 nm, the second light in the second optical system may include a wavelength equal to or larger than 350 nm and equal to or smaller than 550 nm, and an angle of incidence of the second light in the second optical system may include an angle equal to or larger than 60° and equal to or smaller than 85°.

In the above-described inspection apparatus, the determination unit may determine a shape including a size of the defect based on the observation result in the first optical system, and may determine a position of the defect in the thickness direction of the film in a case in which the shape of the defect is a predetermined shape.

In the above-described inspection apparatus, the second optical system may perform changed dark-field observation in which at least any of polarized state changing of changing a polarized state of the second light to a polarized state in which an amount of light transmitted through the film increases, wavelength changing of changing a wavelength of the second light to a wavelength at which the amount of light transmitted through the film increases, and angle-of-incidence changing of changing an angle of incidence of the second light to an angle of incidence at which the amount of light transmitted through the film increases is performed, and the determination unit may acquire height information about the defect from a result of the changed dark-field observation and classify the defect.

In the above-described inspection apparatus, the film may include a pellicle attached to a photomask.

In the above-described inspection apparatus, the objective lens may have a focal depth smaller than a distance between the photomask and the pellicle.

In the above-described inspection apparatus, the film may include a pellicle attached to a photomask, and the first optical system may observe a patterned surface formed on the photomask.

In the above-described inspection apparatus, the photomask may include a photomask for EUV exposure.

An inspection method according to the present disclosure includes the steps of: performing bright-field observation in a first optical system configured to illuminate a film with first light transmitted through the film and receive first observation light from a first surface side of the film; performing dark-field observation in a second optical system configured to illuminate the film from the first surface side with second light reflected from the first surface of the film and receive second observation light from the first surface side; and determining in a determination unit whether a position of a defect of the film, when the first surface side in a thickness direction of the film is located above and a second surface side on an opposite side of the first surface is located below, is the defect above the first surface of the film or the defect below the first surface based on a combination of an observation result of the bright-field observation in the first optical system and an observation result of the dark-field observation in the second optical system.

According to the present disclosure, an inspection apparatus and an inspection method that enable a defect of a film to be determined with high accuracy.

The above and other objects, features and advantages of the present disclosure will become more fully understood from the detailed description given hereinbelow and the accompanying drawings.

### BRIEF DESCRIPTION OF DRAWINGS

FIG. 1 is a configuration diagram illustrating an inspection apparatus according to a first embodiment;

FIG. 2 is a graph illustrating a relationship between angle of incidence on and transmittance through a pellicle for EUV exposure in the inspection apparatus according to the first embodiment, the horizontal axis indicating the angle of incidence on the pellicle and the vertical axis indicating the transmittance through the pellicle;

FIG. 3 is a view illustrating observation results of bright-field observation and dark-field observation in the inspection apparatus according to the first embodiment, showing a case in which a defect is present on a first surface of a film;

FIG. 4 is a view illustrating observation results of bright-field observation and dark-field observation in the inspection apparatus according to the first embodiment, showing a case in which a defect is present on a second surface of the film;

FIG. 5 is a diagram illustrating an observation result determined by a determination unit in the inspection apparatus according to the first embodiment;

FIG. 6 is a block diagram illustrating a processing device in the inspection apparatus according to the first embodiment;

FIG. 7 is a flow chart illustrating an inspection method to be performed through use of the inspection apparatus according to the first embodiment;

FIG. 8 is a flow chart illustrating another inspection method to be performed through use of the inspection apparatus according to the first embodiment;

FIG. 9 is a configuration diagram illustrating an inspection apparatus according to a second embodiment;

FIG. 10 is a cross-sectional view illustrating an arrangement of an objective lens and mirrors in a second optical system in the inspection apparatus according to the second embodiment, showing a cross-section taken along the line A-A in FIG. 9;

FIG. 11 is a cross-sectional view illustrating an arrangement of the objective lens and mirrors in the second optical system in the inspection apparatus according to the second embodiment;

FIG. 12 is a diagram illustrating off-axis illumination in the second optical system in the inspection apparatus according to the second embodiment;

FIG. 13 is a diagram illustrating an observation result of dark-field observation performed by the second optical system in the inspection apparatus according to the second embodiment;

FIG. 14 is a view illustrating observation results of bright-field observation and dark-field observation in the inspection apparatus according to the second embodiment, showing a case in which a pin hole is present in a film;

FIG. 15 is a graph illustrating luminance in observation results of bright-field observation and dark-field observation in the inspection apparatus according to the second embodiment, the horizontal axis indicating the position in the X-axis direction on the film and the vertical axis indicating the luminance;

FIG. 16 is a graph illustrating luminance in the observation results of bright-field observation and dark-field observation in the inspection apparatus according to the second embodiment, the horizontal axis indicating the position in the X-axis direction on the film and the vertical axis indicating the luminance;

FIG. 17 is a view illustrating observation results of bright-field observation and dark-field observation in the inspection apparatus according to the second embodiment, showing a case in which a particle is present on the first surface of a film; and

FIG. 18 is a diagram illustrating an observation result determined by the determination unit in the inspection apparatus according to the second embodiment.

### DESCRIPTION OF EMBODIMENTS

Hereinafter, specific components of the present embodiments will be described with reference to the drawings. The following description presents preferred embodiments of the present disclosure, and the scope of the present disclosure is not limited to the following embodiments. In the following description, components denoted by the same reference character indicate substantially similar content.

### First Embodiment

An inspection apparatus and an inspection method according to a first embodiment will be described.

### <Inspection Apparatus>

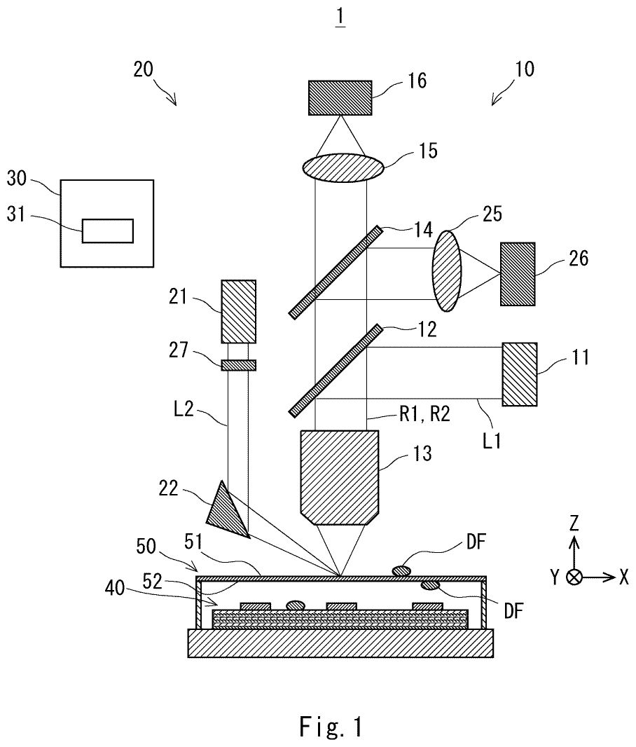

FIG. 1 is a configuration diagram illustrating the inspection apparatus according to the first embodiment. As shown in FIG. 1, an inspection apparatus 1 includes a first optical system 10, a second optical system 20, and a processing device 30. The inspection apparatus 1 inspects a defect DF on a film 50 attached to a sample 40. The defect DF includes a foreign matter adhering to the film 50. Note that the defect DF is not limited to a foreign matter adhering to the film 50, and may include an abnormality of the film 50, such as a protrusion formed on the front surface of the film 50 (which will simply be referred to as a foreign matter on the film in some cases), or a hole (pin hole) or a recess formed in the front surface of the film 50.

The sample 40 includes a photomask, for example. The film 50 includes a pellicle attached to a photomask, for example. The film 50 has a first surface 51 and a second surface 52 on the opposite side of the first surface 51. The second surface 52 is opposed to the sample 40. Thus, the first surface 51 faces the opposite side of the sample 40. The sample 40 may include a photomask for exposure to be performed through use of extreme ultraviolet (EUV) light. In that case, the pellicle is formed to transmit EUV light. Note that the sample 40 is not limited to a photomask and may be another member such as a semiconductor substrate. The film 50 is not limited to a pellicle attached to a photomask and may be another member such as an insulating film and a semiconductor film attached to a semiconductor substrate or the like with a spacer interposed therebetween. The film 50 may be a pellicle before being attached to a photomask. In this case, the sample 40 may not be present in the vicinity of the film 50 when the defect DF on the film 50 is detected.

Herein, the XYZ orthogonal coordinate system is introduced for ease of description. A direction orthogonal to the first surface 51 of the film 50 is referred to as the Z-axis direction, and two directions orthogonal to each other within a plane orthogonal to the Z-axis direction are referred to as the X-axis direction and the Y-axis direction.

The first optical system 10 has a light source 11, a mirror 12, an objective lens 13, a wavelength selection unit 14, a lens 15, and a first detector 16. Note that the first optical system 10 may additionally have members other than them. The light source 11 generates first light L1. The first light L1 includes a wavelength that is at least partially transmitted through the film 50. The first light L1 may include a wavelength that is partially reflected by the film 50 and partially transmitted through the film 50. The first light L1 may include a wavelength that at least partially transmits the first surface 51 of the film 50. For example, the first light L1 in the first optical system 10 may include a wavelength equal to or larger than 600 nm and equal to or smaller than 750 nm. Specifically, the first light L1 may include light having a central wavelength at 630 nm. The first light L1 emitted from the light source 11 is reflected by the mirror 12.

The mirror 12 includes, for example, a half-silvered mirror and a non-polarizing beam splitter, or the like. The mirror 12 reflects a part of the incident first light L1 to the objective lens 13.

The objective lens 13 focuses the first light L1 of the first optical system 10 on the film 50. Therefore, the first optical system 10 illuminates the film 50 with the first light L1 from the first surface 51 side. Note that the first optical system 10 may illuminate the film 50 from the second surface 52 side. In this case, the sample 40 may not be provided, or the first light L1 may be light to be transmitted through the sample 40.

The objective lens 13 has an optical axis extending in the Z-axis direction. The first light L1 focused by the objective lens 13 has an optical axis extending in the Z-axis direction. Therefore, the first optical system 10 makes the optical axis of the first light L1 perpendicular to the first surface 51 of the film 50. The first light L1 is transmitted through the film 50. For example, in a case in which the film 50 is a pellicle, the first light L1 is transmitted through the film 50 by making the wavelength of the first light L1 equal to or larger than 600 nm and equal to or smaller than 750 nm and making the optical axis of the first light L1 perpendicular to the first surface 51 of the film 50.

The objective lens 13 may have a focal depth larger than the thickness of the film 50 from the first surface 51 to the second surface 52. Alternatively, the objective lens 13 may have a focal depth smaller than the distance between the photomask and the pellicle. The first optical system 10 can thereby observe a defect on the first surface 51 and the second surface 52 of the film 50 without being affected by a patterned surface of the photomask. Note that the first optical system 10 may observe the patterned surface formed on the photomask by focusing the first light L1 in the first optical system 10 on the photomask.

The objective lens 13 focuses first observation light R1 from the film 50 illuminated with the first light L1. The optical axis of the first light L1 and the optical axis of the first observation light are orthogonal to the first surface 51 and the second surface of the film 50. Thus, the objective lens 13 focuses the first observation light R1 reflected from the first surface 51 and the second surface of the film 50. The first observation light R1 includes reflected light obtained by reflection of the first light L1 from the first surface 51 and the second surface. As described above, the first optical system 10 illuminates the film 50 with the first light L1 transmitted through the film 50 and receives the first observation light R1 from the first surface 51 side of the film 50. Note that even in a case of illuminating the film 50 from the second surface 52 side in the state in which the sample 40 is not provided or with the first light L1 transmitted through the sample 40, the first optical system 10 illuminates the film 50 with the first light L1 transmitted through the film 50 and receives the first observation light R1 from the first surface 51 side of the film 50. The first optical system 10 thus performs bright-field observation.

The first observation light R1 transmitted through the objective lens 13 enters the mirror 12. The mirror 12 transmits a part of the first observation light R1. The first observation light R1 transmitted through the mirror 12 enters the wavelength selection unit 14.

The wavelength selection unit 14 includes a dichroic mirror, for example. The wavelength selection unit 14 transmits the first observation light R1. The first observation light R1 is thereby caused to enter the lens 15. The lens 15 focuses the incident first observation light R1 to be guided to the first detector 16. It is desirable that the first observation light R1 should be focused on the first detector 16. The first optical system 10 can thereby be a confocal optical system. The first detector 16 detects the first observation light R1. The first detector 16 may be a time delay integration (TDI) sensor or a line sensor.

Note that the wavelength selection unit 14 may guide the first observation light R1 to the first detector 16 through the lens 15 by reflecting the first observation light R1. The wavelength selection unit 14 is not limited to a dichroic mirror as long as the wavelength selection unit 14 can guide the first observation light R1 to the first detector 16, and may be a combination of a half-silvered mirror and a bandpass filter.

The first detector 16 is connected in a state in which the first detector 16 can transfer information to the processing device 30 through a communication network including at least either a wired or wireless network. The first detector 16 outputs an observation result of the bright-field observation in the first optical system 10 to the processing device 30.

The second optical system 20 has a light source 21, a mirror 22, the objective lens 13, the wavelength selection unit 14, a lens 25, and a second detector 26. In the present embodiment, the objective lens 13 that receives the second observation light R2 in the second optical system 20 is common to the objective lens 13 that receives the first observation light R1 in the first optical system 10. In addition, the wavelength selection unit 14 that selects the wavelength of the second observation light R2 in the second optical system 20 may be common to the wavelength selection unit 14 that selects the wavelength of the first observation light R1 in the first optical system 10. Note that the second optical system 20 may additionally have members other than them.

The light source 21 generates second light L2. The second light L2 in the second optical system 20 may include a wavelength equal to or larger than 350 nm and equal to or smaller than 550 nm. Specifically, the second light L2 may include light having a central wavelength of 405 nm. The second light L2 emitted from the light source 21 enters the mirror 22. Note that the second light L2 emitted from the light source 21 may enter the mirror 22 via a polarizing member 27. The polarizing member 27 transforms a polarized state of the second light L2. For example, the polarizing member 27 transforms the polarized state such that the second light L2 includes s-polarized light when entering the film 50.

The mirror 22 reflects the incident second light L2 to the first surface 51 of the film 50. The second light L2 entering the first surface 51 has an optical axis inclined with respect to the first surface 51. As described above, the second optical system 20 uses off-axis illumination in which the optical axis of the second light L2 is inclined with respect to the first surface 51. The second light L2 entered the first surface 51 in an off-axis manner is reflected from the first surface 51. For example, the second light L2 entering the first surface 51 may include s-polarized light.

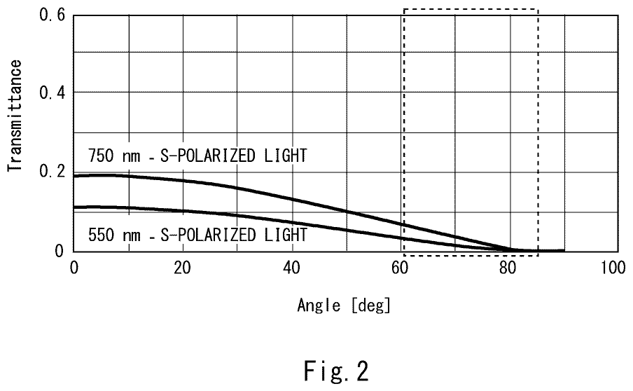

FIG. 2 is a graph illustrating a relationship between angle of incidence on and transmittance through a pellicle for EUV exposure in the inspection apparatus 1 according to the first embodiment, the horizontal axis indicating the angle of incidence on the pellicle and the vertical axis indicating the transmittance through the pellicle. FIG. 2 shows transmittance of s-polarized light having a central wavelength of 750 nm and s-polarized light having a central wavelength of 550 nm.

As shown in FIG. 2, the transmittance decreases as the angle of incidence increases. In the present embodiment, the angle of incidence of the second light L2 in the second optical system 20 includes an angle equal to or larger than 60° and equal to or smaller than 85°. The angle of incidence of the second light L2 in the second optical system 20 may include an angle equal to or larger than 60° and smaller than 90°. Specifically, the angle of incidence of the second light L2 includes an angle equal to or larger than 70° which is the Brewster angle.

For example, in the case in which the film 50 is a pellicle, the second light L2 can be reflected from the first surface 51 of the film 50 by making the wavelength of the second light L2 equal to or larger than 350 nm and equal to or smaller than 550 nm, having the second light L2 include s-polarized light, and making the angle of incidence of the optical axis of the second light L2 equal to or larger than 60° and equal to or smaller than 85°.

The objective lens 13 focuses, from the first surface 51 side, the second observation light R2 having an element in the +Z-axis direction in reaction light of the second light L2 from the film 50. The second observation light R2 includes scattered light scattered by the defect DF on the first surface 51, for example. Therefore, the second optical system 20 illuminates the film 50 from the first surface 51 side with the second light L2 being reflected from the first surface 51 of the film 50 and receives the second observation light R2 from the first surface 51 side. The second optical system 20 thereby performs dark-field observation.

The second observation light R2 transmitted through the objective lens 13 enters the mirror 12. The mirror 12 transmits a part of the second observation light R2. The second observation light R2 transmitted through the mirror 12 enters the wavelength selection unit 14.

The wavelength selection unit 14 reflects the second observation light R2, thereby causing the second observation light R2 to enter the lens 25. The lens 25 focuses the incident second observation light R2 to be guided to the second detector 26. It is desirable that the second observation light R2 should be focused on the second detector 26. The second optical system 20 can thereby be a confocal optical system. The second detector 26 detects the second observation light R2. The second detector 26 may be a TDI sensor or a line sensor.

Note that the wavelength selection unit 14 may guide the second observation light R2 to the second detector 26 via the lens 25 by transmitting the second observation light R2. The wavelength selection unit 14 is not limited to a dichroic mirror as long as the wavelength selection unit 14 can guide the second observation light R2 to the second detector 26, and may be a combination of a half-silvered mirror and a bandpass filter.

The second detector 26 is connected in the state in which the second detector 26 can transfer information to the processing device 30 through a communication network including at least either a wired or wireless network. The second detector 26 outputs an observation result of the dark-field observation in the second optical system 20 to the processing device 30.

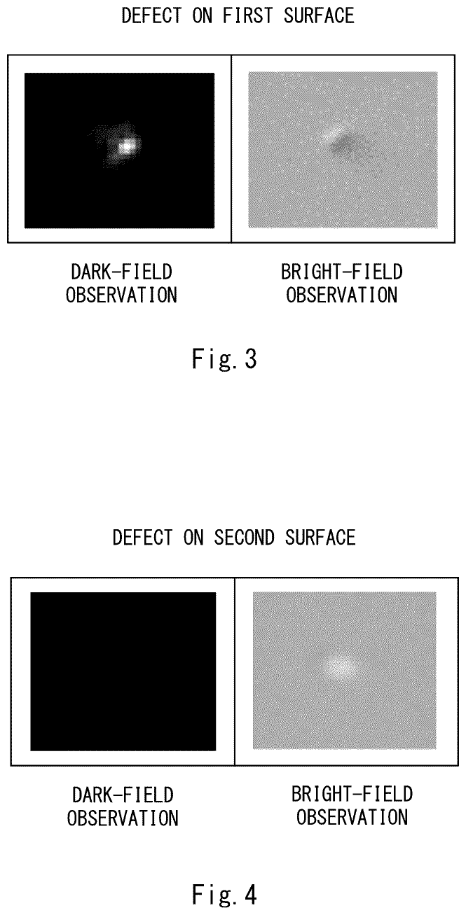

The processing device 30 receives the observation results from the first detector 16 and the second detector 26. FIGS. 3 and 4 are views illustrating the observation results of bright-field observation and dark-field observation in the inspection apparatus 1 according to the first embodiment. FIG. 3 shows a case in which the defect DF is present on the first surface 51 of the film 50, and FIG. 4 shows a case in which the defect DF is present on the second surface 52 of the film 50.

In a case in which the defect DF is present on neither the first surface 51 nor the second surface 52, the first optical system 10 receives the first observation light R1 obtained by reflection of the first light L1 from the film 50. Thus, in the case in which the defect DF is present on neither the first surface 51 nor the second surface 52, the first optical system 10 acquires a white bright-field image. However, when the defect DF such as a foreign matter is present on the first surface 51 of the film 50 as shown in FIG. 3, the first light L1 in the bright-field observation is scattered by the defect DF. Specifically, when the defect DF is present on the first surface 51, the first observation light R1 lacks a portion of the reflected light of the first light L1 scattered by the defect DF. The first optical system 10 can thereby observe the defect DF such as a foreign matter as a portion reduced in luminance in the bright-field observation.

In the case in which the defect DF is not present on the first surface 51, the second light L2 reflected from the first surface 51 is reflected at an angle of reflection equal to the angle of incidence. Thus, the second light L2 reflected from the first surface 51 does not enter the objective lens 13. Accordingly, the second optical system 20 cannot receive the second observation light R2 including reflected light of the second light L2 reflected from the film 50. In the case in which the defect DF is not present on the first surface 51, the second optical system 20 acquires a black dark-field image. However, in the case in which the defect DF is present on the first surface 51 of the film 50 as shown in FIG. 3, the second light L2 is scattered by the defect DF. Thus, the second observation light R2 includes scattered light of the second light L2 scattered by the defect DF. The second optical system 20 can thereby observe the defect DF such as a foreign matter as a portion having luminance higher than that of the surroundings in the dark-field observation.

As shown in FIG. 4, when the defect DF such as a foreign matter is present on the second surface 52, the first light L1 in the bright-field observation is scattered by the defect DF. Therefore, the first observation light R1 lacks a portion of the reflected light of the first light L1 scattered by the defect DF. The first optical system 10 can thereby observe the defect DF such as a foreign matter as a portion reduced in luminance in the bright-field observation.

On the other hand, the second light L2 is not scattered by the defect DF on the second surface 52 because of being reflected from the first surface 51 of the film 50. Therefore, in the case in which the defect DF such as a foreign matter is present on the second surface 52 as shown in FIG. 4, the second observation light R2 does not include scattered light of the second light L2 scattered by the defect DF. Accordingly, the second optical system 20 does not (cannot) observe the defect DF present on the second surface 52 in the dark-field observation.

The processing device 30 has a determination unit 31. The determination unit 31 has a function as determination means. The determination unit 31 determines the position of the defect DF in the thickness direction of the film 50 based on the combination of the observation result of the bright-field observation in the first optical system 10 and the observation result of the dark-field observation in the second optical system 20. In other words, the determination unit 31 determines whether the defect DF is the defect DF above the first surface 51 of the film 50 or the defect DF below the first surface 51 based on the combination of the observation result of the bright-field observation in the first optical system 10 and the observation result of the dark-field observation in the second optical system 20. Herein, the first surface side in the thickness direction of the film 50 shall be located above, and the second surface side shall be located below. The defect below the first surface 51 may include the defect DF such as a hole (pin hole) or a recess in the film 50 or the defect DF due to a foreign matter on the second surface. The determination unit 31 may determine whether the defect DF on the film 50 is the defect DF on the first surface 51 of the film 50 or the defect DF on the second surface 52 based on the combination of the observation result of the bright-field observation in the first optical system 10 and the observation result of the dark-field observation in the second optical system 20. Herein, the defect DF on the first surface 51 of the film 50 includes the defect DF due to a foreign matter on the first surface 51 of the film 50, and the defect DF on the second surface 52 of the film 50 includes the defect DF due to a foreign matter on the second surface 52 of the film 50.

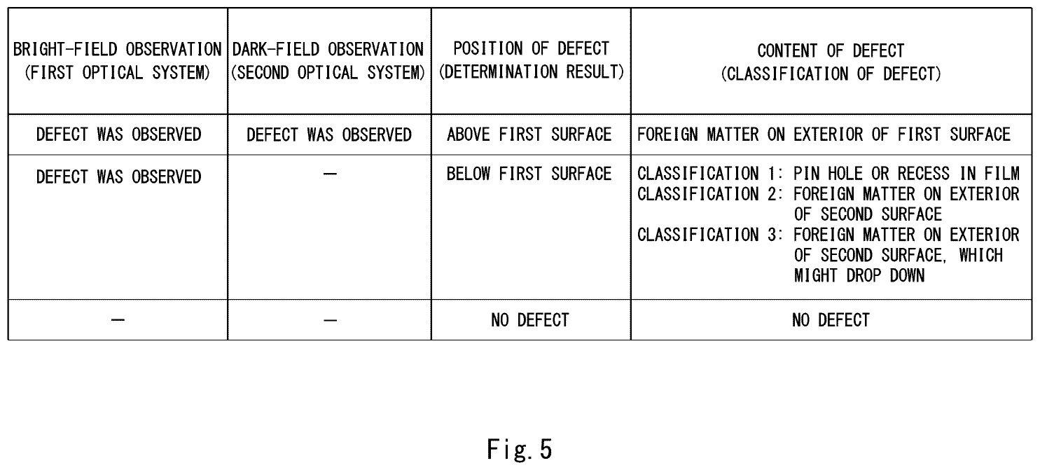

FIG. 5 is a diagram illustrating an observation result determined by the determination unit 31 in the inspection apparatus 1 according to the first embodiment. As shown in FIG. 5, in the case in which the defect DF is observed both in the observation result in the first optical system 10 (the bright-field observation: the wavelength of the first light L1 is 630 nm, for example) and the observation result in the second optical system 20 (the dark-field observation: the second light L2 has the wavelength of 405 nm and includes s-polarized light, for example), the determination unit 31 determines that the defect DF is the defect DF above the first surface 51 of the film 50. On the other hand, in the case in which the defect DF is observed in the observation result in the first optical system 10 and in which the defect DF is not observed in the observation result in the second optical system 20, the determination unit 31 determines that the defect DF is the defect DF below the first surface 51 of the film 50. FIG. 5 is an example. Depending on the adjustment of the inspection apparatus 1, as in the second embodiment described later, a pin hole and a recess among defects DF below the first surface 51 of the film 50 may be observed in the observation results in the second optical system 20. In such a case, in which the defect DF is observed in the observation result in the first optical system 10 and in which the defect DF is not observed in the observation result in the second optical system 20, the determination unit 31 may determine that defect DF is the defect due to a foreign matter on the second surface 52 of the film 50.

### Modified Example 1

The determination unit 31 may determine the size of the defect DF and the shape of the defect DF based on the observation result in the first optical system 10. The size of the defect DF and the shape of the defect as seen in the direction orthogonal to the first surface 51 can be determined because the optical axis of the first observation light R1 in the first optical system 10 is orthogonal to the first surface 51. For example, in a case in which the size of the observed defect DF is equal to or larger than a predetermined threshold value such that the defect DF can be determined as a foreign matter or the like or in a case in which the shape of the defect DF is a predetermined shape such that the defect DF can be determined as a foreign matter, the determination unit 31 may determine whether a foreign matter is present on the first surface 51 or the second surface 52 of the film 50 (Classification 2). In a case in which the size (or shape) of the defect DF is equal to or larger than a predetermined second threshold value and in which the defect DF is determined as a foreign matter on the second surface 52 of the film 50, the determination unit 31 may classify the defect DF as the defect DF which might drop down from the second surface 52 of the film 50 to the sample 40 (Classification 3).

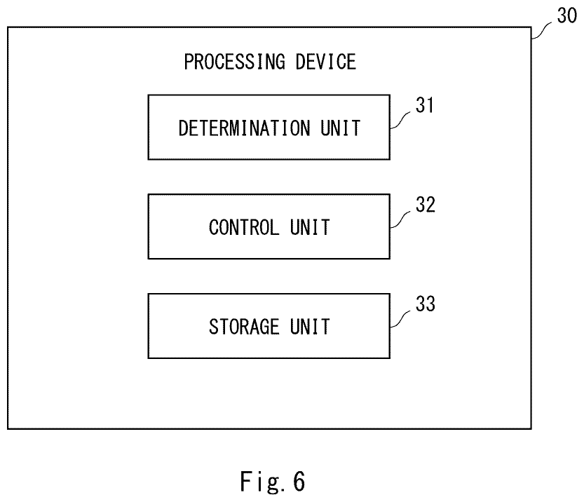

FIG. 6 is a block diagram illustrating the processing device 30 in the inspection apparatus 1 according to the first embodiment. As shown in FIG. 6, the processing device 30 may additionally have a control unit 32 and a storage unit 33 besides the determination unit 31. The control unit 32 and the storage unit 33 have functions as control means and storage means, respectively. The processing device 30 includes an information processing device such as a personal computer (PC) or a server.

### Modified Example 2

The control unit 32 controls operation of the determination unit 31 and the storage unit 33 in the processing device 30. The control unit 32 may also control operation of the first optical system 10 and the second optical system 20. Specifically, for example, in any case of (i) when it is concluded that the defect DF is present on the second surface 52 of the film 50, (ii) when it is concluded that the defect DF is a defect having a predetermined shape based on the observation result in the first optical system 10, and (iii) when it is concluded that the defect DF is present on the second surface 52 of the film 50 and when it is concluded that the defect DF is a defect having the predetermined shape based on the observation result in the first optical system 10, the control unit 32 causes the second optical system 20 to perform at least any of polarized state changing, wavelength changing, and angle-of-incidence changing.

In the wavelength changing, the second optical system 20 changes the wavelength of the second light L2 to a wavelength at which the amount of light transmitted through the film 50 increases. Specifically, for example, the second optical system 20 elongates the wavelength of the second light L2 to be equal to or larger than 600 nm and equal to or smaller than 750 nm, or the like. Note that the second optical system 20 may change the wavelength of the second light L2 to a wavelength other than the wavelength equal to or larger than 600 nm and equal to or smaller than 750 nm, or the like as long as the amount of the second light L2 transmitted through the film 50 can be increased.

In the angle-of-incidence changing, the second optical system 20 changes the angle of incidence of the second light L2 to an angle of incidence at which the amount of light transmitted through the film 50 increases. Specifically, for example, the second optical system 20 may make the angle of incidence of the second light L2 smaller than 60°. In the polarized state changing, the second optical system 20 controls the polarizing member 27 to make a change such that the second light L2 becomes p-polarized light, for example. The second optical system 20 performs dark-field observation in which at least any of the polarized state changing, the wavelength changing, and the angle-of-incidence changing is performed. The dark-field observation in which at least any of the polarized state changing, the wavelength changing, and the angle-of-incidence changing is performed will be called changed dark-field observation.

The determination unit 31 acquires height information about the defect DF from a result of the changed dark-field observation and classifies the defect DF. Specifically, in a case in which the height of the defect DF is equal to or larger than a predetermined first threshold value, for example, the determination unit 31 may classify the defect DF as a foreign matter (Classification 2). In a case in which the height of the defect DF is equal to or larger than a predetermined second threshold value, the determination unit 31 may classify the defect DF as the defect DF which might fall down from the second surface 52 of the film 50 to the sample 40 (Classification 3). Note that in a case in which the height of the defect DF is smaller than the predetermined first threshold value, the determination unit 31 may classify the defect DF as the defect DF other than a foreign matter, such as a hole (pin hole) or a recess (Classification 1).

The storage unit 33 stores an observation result. The storage unit 33 may store observation conditions for the first optical system 10 and the second optical system 20. The storage unit 33 may store the height information about the defect DF and the classification of the defect DF in association with each other.

### Modified Example 3

The first optical system 10 may observe a patterned surface formed on a photomask by focusing the first light L1 in the first optical system 10 on the photomask.

### <Inspection Method>

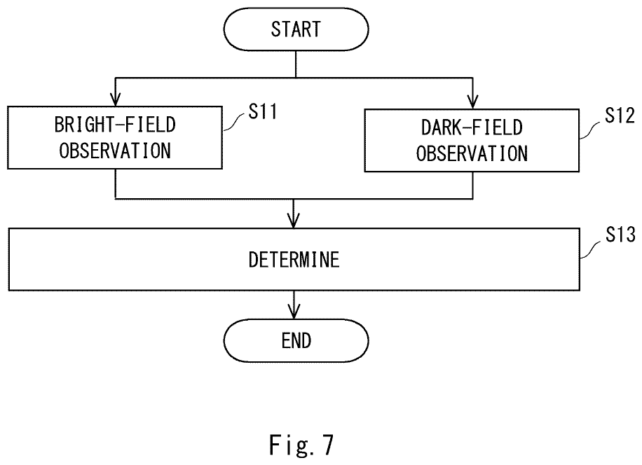

Next, an inspection method to be performed through use of the inspection apparatus 1 will be described. FIG. 7 is a flow chart illustrating the inspection method to be performed through use of the inspection apparatus 1 according to the first embodiment. In FIG. 7, step S11 of the bright-field observation and step S12 of the dark-field observation are executed in parallel (concurrently), but the present disclosure is not limited to this. Step S11 of the bright-field observation may be executed before step S12 of the dark-field observation, or step S11 of the bright-field observation may be executed after step S12 of the dark-field observation.

As shown in step S11 in FIG. 7, the bright-field observation is performed. Specifically, for example, the control unit 32 may control the first optical system 10 so as to perform the bright-field observation of the film 50 in the first optical system 10. The first optical system 10 illuminates the film 50 with the first light L1 transmitted through the film 50 and receives the first observation light R1 from the first surface 51 side of the film 50. In step S11 of performing the bright-field observation, the first optical system 10 may make the optical axis of the first light L1 perpendicular to the first surface 51 of the film 50.

Next, as shown in step S12, the dark-field observation is performed. Specifically, for example, the control unit 32 may control the second optical system 20 so as to perform the dark-field observation of the film 50 in the second optical system 20. The second optical system 20 illuminates the film 50 from the first surface 51 side with the second light L2 reflected from the first surface 51 of the film 50 and receives the second observation light R2 from the first surface 51 side. In step S12 of performing the dark-field observation, the second optical system 20 may use off-axis illumination in which the optical axis of the second light L2 is inclined with respect to the first surface 51 of the film 50. The objective lens 13 that receives the second observation light R2 in the second optical system 20 may be common to the objective lens 13 that receives the first observation light R1 in the first optical system 10.

Next, as shown in step S13, the determination unit 31 makes a determination. Specifically, the determination unit 31 determines the position of the defect DF in the thickness direction of the film 50 based on the combination of the observation result of the bright-field observation in the first optical system 10 and the observation result of the dark-field observation in the second optical system 20. In other words, the determination unit 31 determines whether the defect DF is the defect DF above the first surface 51 of the film 50 or the defect DF below the first surface 51 based on the combination of the observation result of the bright-field observation in the first optical system 10 and the observation result of the dark-field observation in the second optical system 20. The determination unit 31 may determine whether the defect DF on the film 50 is the defect DF on the first surface 51 of the film 50 or the defect DF on the second surface 52 based on the combination of the observation result of the bright-field observation in the first optical system 10 and the observation result of the dark-field observation in the second optical system 20. In determining step S13, the determination unit 31 may determine that the defect DF is the defect DF above the first surface 51 of the film 50 in the case in which the defect DF is observed both in the observation result in the first optical system 10 and the observation result in the second optical system 20. The determination unit 31 may determine that the defect DF is the defect DF below the first surface 51 of the film 50 in a case in which the defect DF is detected in the observation result in the first optical system 10 and in which the defect DF is not detected in the observation result in the second optical system 20.

The determination unit 31 may determine a shape including the size of the defect DF based on the observation result in the first optical system 10 and classify the defect DF.

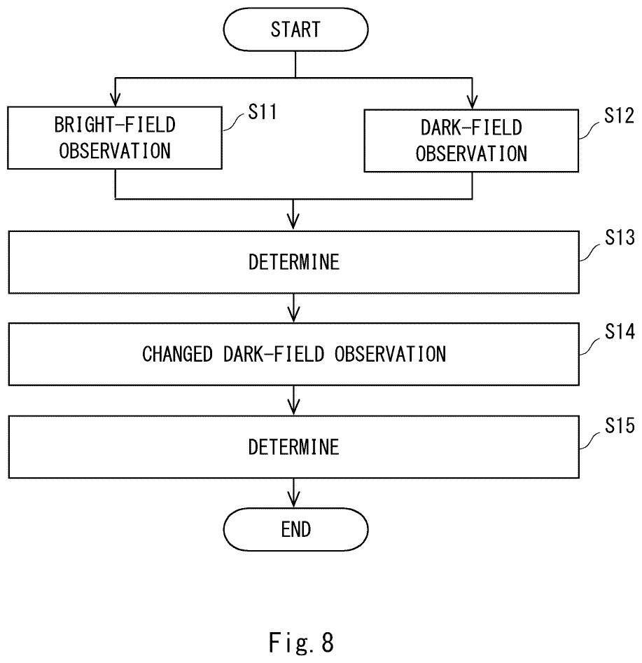

FIG. 8 is a flow chart illustrating another inspection method to be performed through use of the inspection apparatus 1 according to the first embodiment. As shown in FIG. 8, step S14 of the changed dark-field observation including the polarized state changing, the wavelength changing, and the angle-of-incidence changing as well as step S15 of determining the defect DF may additionally be included.

As shown in step S14, in a case in which it is concluded that the defect DF is present on the second surface 52 of the film 50 and in which it is concluded that the defect DF is the defect DF having a predetermined shape based on the observation result in the first optical system 10, the control unit 32 controls the second optical system 20 so as to perform the changed dark-field observation in which at least any of the polarized state changing, the wavelength changing, and the angle-of-incidence changing is performed. Herein, the wavelength changing in the second optical system 20 is to change the wavelength of the second light L2 to a wavelength at which the amount of light transmitted through the film 50 increases. The angle-of-incidence changing is to change the angle of incidence of the second light L2 to an angle of incidence at which the amount of light transmitted through the film 50 increases. The polarized state changing is to change the polarized state of the second light L2 to a polarized state in which the amount of light transmitted through the film 50 increases.

Next, as shown in step S15, height information is determined and the classification of the defect is determined. Specifically, the determination unit 31 acquires height information about the defect from the changed dark-field observation in which at least any of the polarized state changing, the wavelength changing, and the angle-of-incidence changing is performed in the second optical system 20, and classifies the defect DF.

Next, effects of the present embodiment will be described. The determination unit 31 of the present embodiment determines whether defects are present on the first surface 51 and the second surface 52 of the film 50 based on the combination of the observation result of the bright-field observation and the observation result of the dark-field observation. Specifically, for example, detection of a defect such as a foreign matter on a pellicle and front and rear separate detection are performed based on the combination of the bright-field observation (perpendicular incidence) that enables detection of defects on the front and rear surfaces of the pellicle and the dark-field observation (off-axis incidence) of detecting only a defect on the front surface. The inspection apparatus 1 can thereby determine a defect of the film 50 with high accuracy.

In the first optical system 10, the optical axis of the first light L1 is perpendicular to the first surface 51. Thus, the inspection apparatus 1 can determine the shape including the size of the defect DF with the first light L1 in the bright-field observation. Specifically, the diameter of a foreign matter can be calculated from the defect detected in the bright-field observation.

It is assumed that a defect such as a foreign matter having a predetermined size and a predetermined shape, if adhering to a pellicle, causes a breakage. The present embodiment can prevent the breakage because the defect having the predetermined size and the predetermined shape can be determined.

The foreign n matter having the predetermined size and the predetermined shape and adhering to the pellicle drops down on the photomask because of a temperature rise or the like in some cases. The present embodiment can prevent the drop onto the photomask because the defect having the predetermined size and the predetermined shape can be determined.

The second optical system 20 uses off-axis illumination in which the optical axis of the second light L2 is inclined with respect to the first surface 51. Additionally, the second optical system 20 uses off-axis illumination with a short-wavelength of visible light and s-polarized light. Thus, the second optical system 20 can perform the dark-field observation to detect only a defect on the front surface of a pellicle. Thus, on which of the first surface 51 and the second surface 52 of the film 50 the defect DF is present can be distinguished.

In the case in which it is concluded that the defect DF is present on the second surface 52 of the film 50 and it is concluded that the defect DF is a defect having the predetermined shape based on the observation result in the first optical system 10, the second optical system 20 performs changed dark-field observation in which at least either of wavelength changing of the second light L2 and angle-of-incidence changing of the second light is performed. The determination unit 31 thereby acquires the height information about the defect DF and classifies the defect DF. Therefore, the inspection apparatus 1 can determine the classification of the defect of the film 50 with high accuracy.

The use of different wavelengths for the bright-field observation and the dark-field observation enables the bright-field observation and the dark-field observation to be performed concurrently through observation with a single scan. An observation time can thereby be shortened.

### Second Embodiment

Next, an inspection apparatus and an inspection method according to a second embodiment will be described. The present embodiment performs off-axis illumination for the dark-field observation in the second optical system 20 along optical paths in a plurality of directions arranged in a ring-shaped manner around the objective lens 13. The defect DF such as a pin hole is determined based on an observation result of the dark-field observation.

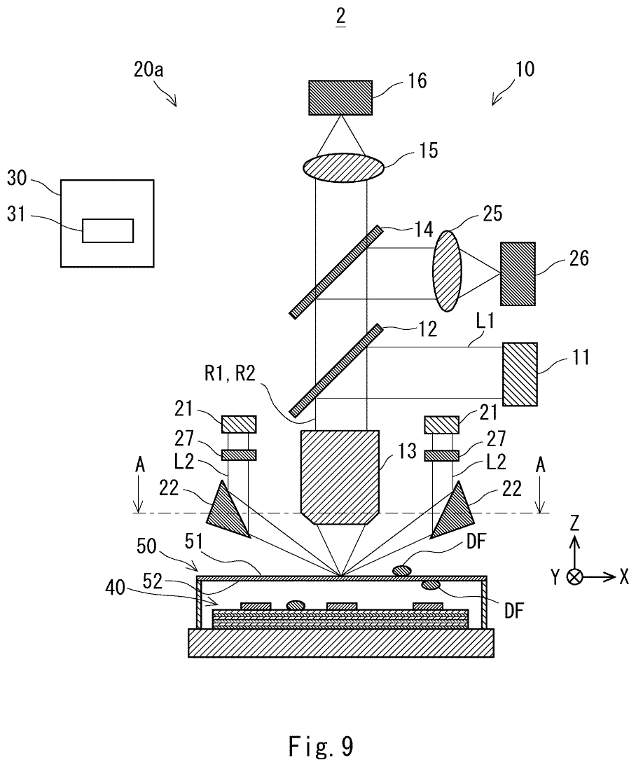

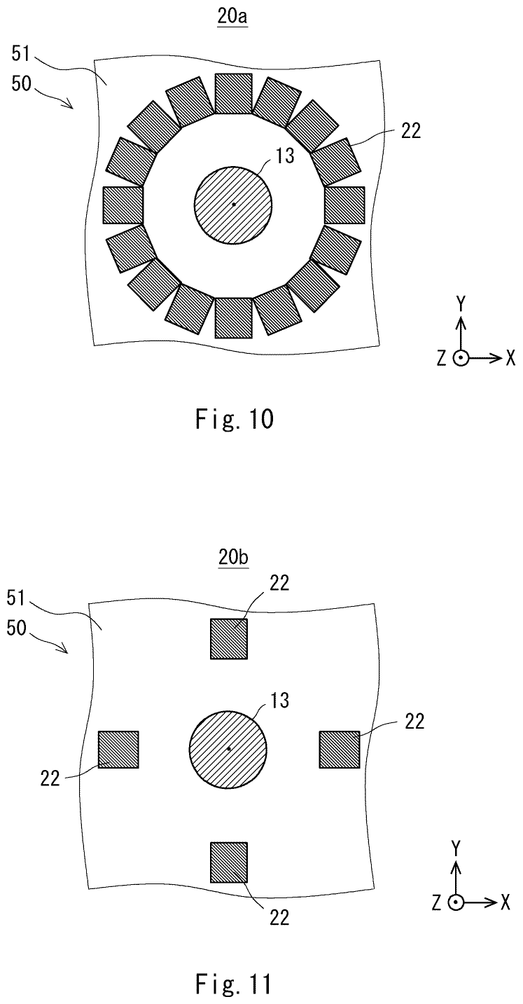

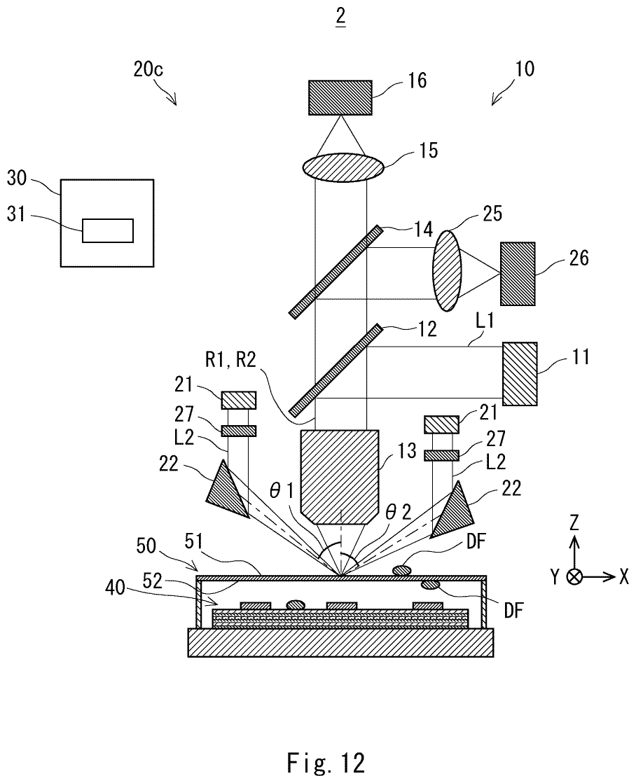

FIG. 9 is a configuration diagram illustrating an inspection apparatus 2 according to the second embodiment. FIG. 10 is a cross-sectional view illustrating an arrangement of the objective lens 13 and mirrors 22 in a second optical system 20a in the inspection apparatus 2 according to the second embodiment, showing a cross-section taken along the line A-A in FIG. 9. FIG. 11 is a cross-sectional view illustrating an arrangement of the objective lens 13 and the mirrors 22 in a second optical system 20b in the inspection apparatus 2 according to the second embodiment. FIG. 12 is a diagram illustrating off-axis illumination in a second optical system 20c in the inspection apparatus 2 according to the second embodiment.

As shown in FIG. 9, in the inspection apparatus 2 of the present embodiment, the second optical system 20a uses off-axis illumination in which the optical axis of the second light L2 is inclined with respect to the first surface 51 in a plurality of directions. The plurality of directions include, for example, directions toward an irradiated point of the second light L2 from around the objective lens 13. In other words, the plurality of directions include radial directions around the irradiated point at which the first surface 51 is irradiated with the second light L2 as seen in the Z-axis direction. As shown in FIG. 10, the second optical system 20a may use the plurality of mirrors 22 provided at a plurality of positions annularly surrounding the periphery of the objective lens 13 that receives the second observation light R2. The second optical system 20a performs off-axis illumination on the irradiated point along a plurality of optical paths formed by the plurality of mirrors 22. Note that the off-axis illumination may be off-axis illumination along a plurality of optical paths using the ring-shaped mirror 22. The second optical system 20a may perform off-axis illumination along a plurality of optical paths by using a plurality of optical fibers arranged to surround the objective lens 13 additionally to the mirrors 22 or in place of the mirrors 22. Alternatively, as shown in FIG. 11, the off-axis illumination may not be in the ring shape as long as at least the film 50 can be illuminated in the plurality of directions. The angle of incidence on the first surface 51 of the film 50 in the off-axis illumination may be a constant angle in all the directions, or as shown in FIG. 12, a plurality of angles of incidence may be used. For example, the angle of incidence in the off-axis illumination may have an angle θ1 and an angle θ2 different from the angle θ1, or the like.

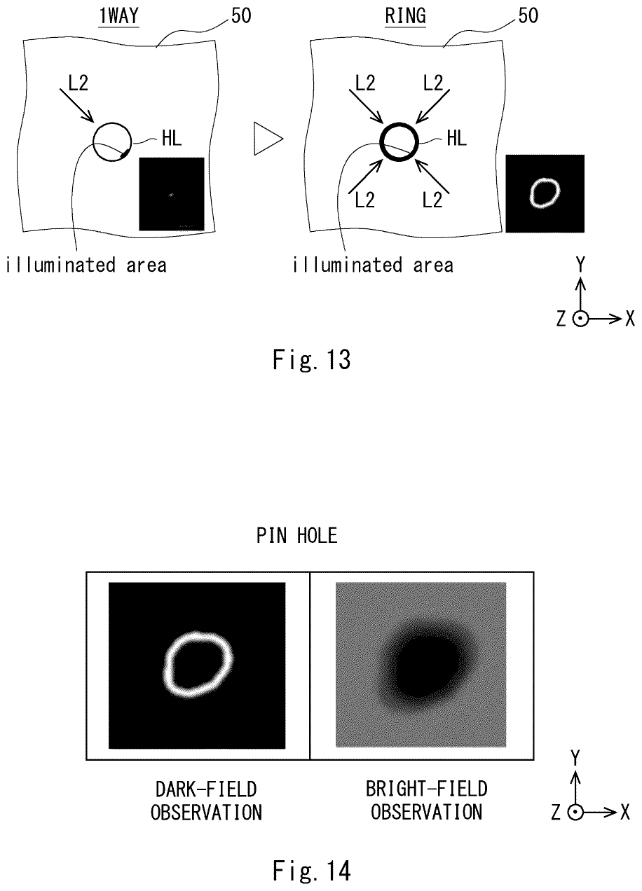

FIG. 13 is a diagram illustrating an observation result of the dark-field observation in the second optical system 20a in the inspection apparatus 2 according to the second embodiment. As shown in FIG. 13, in the case of off-axis illumination of causing the second light L2 to enter in one direction (1 WAY), it is difficult to detect the pin hole HL in some cases because an illumination area at an edge of the pin hole HL is small. On the other hand, in the case of off-axis illumination of causing the second light L2 to enter in a plurality of directions (RING) presenting the ring shape, characteristics specific to the pin hole HL including scattered light from the edge of the pin hole HL can be detected because the illumination area in the pin hole HL covers the entire edge of the pin hole HL. Note that the pin hole HL includes a hole extending through the film 50 from the first surface 51 to the second surface 52. In the film 50 such as a pellicle, a recess is formed in the front surface of the film 50 in some cases. A recess which will be described later includes a recess formed in the first surface 51 of the film 50.

FIG. 14 is a view illustrating observation results of the bright-field observation and the dark-field observation in the inspection apparatus 2 according to the second embodiment, showing the case in which the pin hole HL is present in the film 50. When the pin hole HL is formed in the film 50 as shown in the right view of FIG. 14, the first light L1 in the bright-field observation passes through the portion of the pin hole HL. Therefore, the first observation light R1 lacks the portion of reflected light of the first light L1 passed through the pin hole HL. In the bright-field observation, the first optical system 10 can thereby observe the portion of the pin hole HL as a portion reduced in luminance. In the bright-field observation, central luminance of the portion of the pin hole HL is equal to or smaller than a predetermined threshold value. The threshold value may be set as luminance of the portion of the pin hole HL in advance, for example.

In a case in which a recess is formed in the first surface 51 although not shown in the drawing, the first light L1 in the bright-field observation enters the recess. A part of the first light L1 incident on the recess is scattered at a wall surface and a bottom surface of the recess. Accordingly, the part of the first light L1 incident on the recess is not focused by the objective lens 13 as reflected light. However, another part of the first light L1 incident on the recess is reflected from the bottom surface of the recess and is focused by the objective lens 13 as reflected light. Therefore, the first observation light R1 includes reflected light reflected from the bottom surface of the recess in the reflected light of the first light L1, but lacks the portion scattered by the recess. In the bright-field observation, the first optical system 10 can thereby observe the portion of the recess as a portion reduced in luminance and as a portion having luminance exceeding a predetermined threshold value. Thus, in the bright-field observation, the central luminance of the portion of the recess is low luminance although exceeding the predetermined threshold value.

As shown in the left view of FIG. 14, the second light L2 in the dark-field observation in the off-axis illumination is scattered at the edge of the pin hole HL. In the present embodiment, the second light L2 is scattered at the entire edge of the pin hole HL because the off-axis illumination causes the second light L2 to enter in the plurality of directions. Therefore, the second observation light R2 includes scattered light of the second light L2 scattered at the entire edge of the pin hole HL. The second optical system 20a can thereby observe the edge of the pin hole HL as a portion having high luminance in the dark-field observation.

In the case in which the recess is formed in the first surface 51 although not shown in the drawing, the second light L2 in the dark-field observation in the off-axis illumination is scattered at the edge of the recess. In the present embodiment, the second light L2 is scattered at the entire edge of the recess because the off-axis illumination causes the second light L2 to enter in the plurality of directions. Therefore, the second observation light R2 includes scattered light of the second light L2 scattered at the entire edge of the recess. Thus, the second optical system 20a can observe the edge of the recess as a portion having high luminance in the dark-field observation.

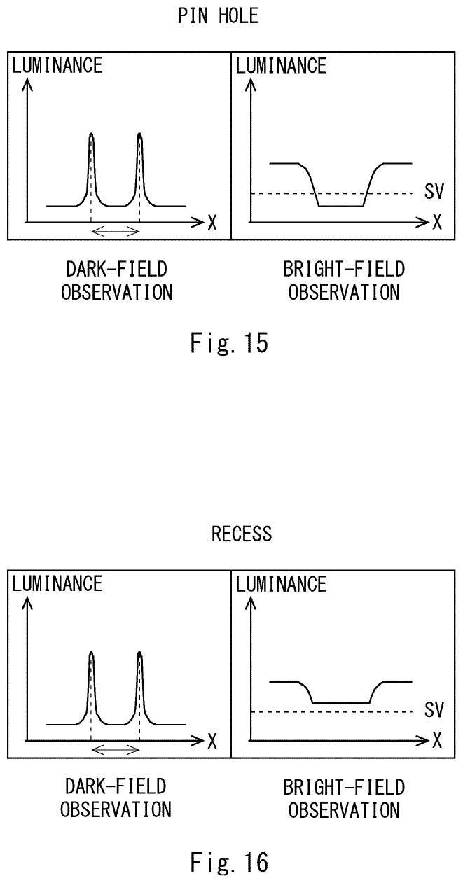

FIGS. 15 and 16 are graphs illustrating luminance in the observation results of the bright-field observation and the dark-field observation in the inspection apparatus 2 according to the second embodiment, the horizontal axis indicating the position in the X-axis direction on the film 50 and the vertical axis indicating the luminance. In a case in which a ring-shaped defect is observed in the dark-field observation as shown in FIGS. 15 and 16, whether the defect formed in the film 50 is the pin hole HL or the recess can be determined by the central luminance of the defect in the bright-field observation.

In the case of the bright-field observation of the film 50 in which the pin hole HL and the recess are formed as shown in FIGS. 15 and 16, a change in luminance made by the edges of the pin hole HL and the recess is gentle, which makes it difficult to determine the edges of the pin hole HL and the recess. In contrast, in the case of the dark-field observation, a change in luminance made by the edges of the pin hole HL and the recess is steep. Thus, the edges of the pin hole HL and the recess can be determined. The sizes of the diameters of the pin hole HL and the recess in the first surface 51 can thereby be determined.

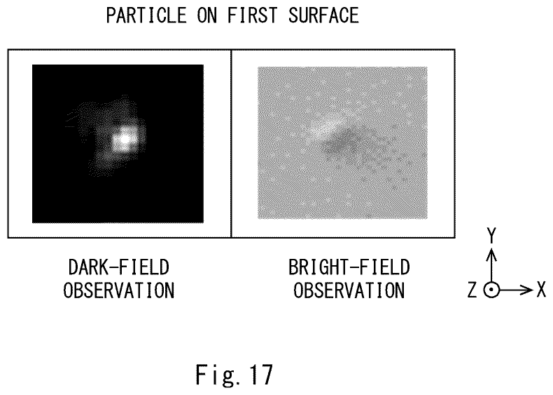

FIG. 17 is a view illustrating the observation results of the bright-field observation and the dark-field observation in the inspection apparatus 2 according to the second embodiment, showing a case in which a particle is present on the first surface 51 of the film 50. When a particle is present on the first surface 51 of the film 50 as shown in FIG. 17, the first light L1 in the bright-field observation is scattered by the particle. The first optical system 10 can thereby observe the particle as a portion reduced in luminance in the bright-field observation.

On the other hand, the second light L2 in the dark-field observation in the off-axis illumination is scattered by the particle. The second optical system 20 can thereby observe the particle as a portion having luminance higher than that of the surroundings in the dark-field observation. In the present embodiment, luminance of scattered light due to the particle can be made higher than the luminance in FIG. 3 because the off-axis illumination causes the second light L2 to enter in the plurality of directions, which can improve detection accuracy.

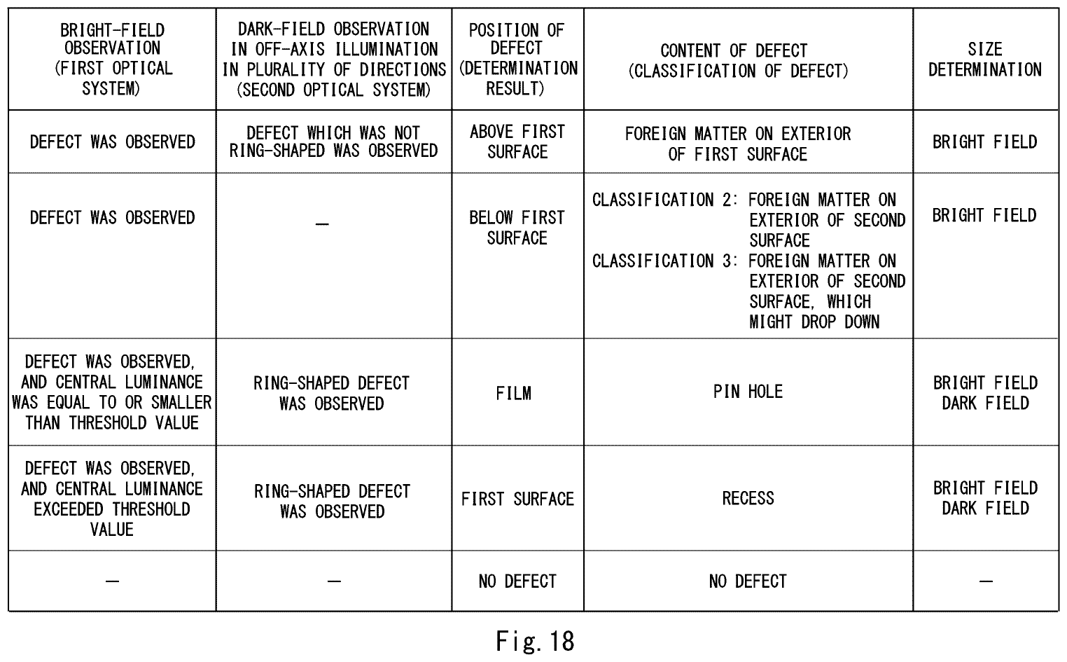

FIG. 18 is a diagram illustrating an observation result determined by the determination unit 31 in the inspection apparatus 2 according to the second embodiment. As shown in FIG. 18, in a case in which the defect DF is observed both in the observation result of the bright-field observation in the first optical system 10 and the observation result of the dark-field observation in the second optical system 20 in the off-axis illumination in the plurality of directions and in which a defect which is not ring-shaped is observed in the dark-field observation, the determination unit 31 determines that the defect DF is the defect DF above the first surface 51 of the film 50. In this case, the determination unit 31 determines the size of the diameter of the defect on the first surface 51 through the bright-field observation.

On the other hand, in the case in which the defect DF is observed in the observation result in the first optical system 10 and in which the defect DF is not observed in the observation result in the second optical system 20, the determination unit 31 determines that the defect DF is the defect DF below the first surface 51 of the film 50. The determination unit 31 determines the size of the diameter of the defect projected on the first surface 51 through the bright-field observation. Classification 2 and Classification 3 have been described earlier.

The determination unit 31 determines that the defect DF is the pin hole HL formed in the film 50 in a case in which the defect DF is observed both in the observation result of the bright-field observation in the first optical system 10 and the observation result of the dark-field observation in the second optical system 20 in the off-axis illumination in the plurality of directions and in a case in which a ring-shaped defect is observed in the dark-field observation and in which the central luminance of the defect in the bright-field observation is equal to or smaller than a threshold value. In this case, the determination unit 31 determines the size of the pin hole HL based on the bright-field observation and the dark-field observation. That is, the determination unit 31 determines that the defect DF is the pin hole HL based on the observation results of the bright-field observation and the dark-field observation, and determines the size of the diameter of the pin hole HL in the first surface 51 based on the observation result of the dark-field observation.

The determination unit 31 determines that the defect DF is the recess formed in the film 50 in the case in which the defect DF is observed both in the observation result of the bright-field observation in the first optical system 10 and the observation result of the dark-field observation in the second optical system 20 in the off-axis illumination in the plurality of directions and in a case in which a ring-shaped defect is observed in the dark-field observation and in which the central luminance of the defect in the bright-field observation exceeds the threshold value. In this case, the determination unit 31 determines the size of the recess based on the bright-field observation and the dark-field observation. That is, the determination unit 31 determines that the defect DF is the recess based on the observation results of the bright-field observation and the dark-field observation, and determines the size of the diameter of the recess in the first surface 51 based on the observation result of the dark-field observation.

The determination unit 31 may determine the classification of the defect DF based on the observation result of the dark-field observation in the off-axis illumination in the plurality of directions in the second optical system 20. That is, in the case in which the defect DF is observed by the dark-field observation in the second optical system 20, the determination unit 31 determines that the defect DF is any of a foreign matter, the pin hole HL, and the recess on the first surface 51. In the case in which the defect DF is not observed by the dark-field observation in the second optical system 20, the determination unit 31 determines that the defect DF is a foreign matter below the first surface 51 or determines that a defect is not present. In a case in which the defect DF which is not ring-shaped is observed based on the observation result of the dark-field observation in the second optical system 20, the determination unit 31 determines that the defect DF is a foreign matter on the first surface 51. In the case in which the ring-shaped defect DF is observed based on the observation result of the dark-field observation in the second optical system 20, the determination unit 31 determines that the defect DF is either of the pin hole HL and the recess. In the case in which the ring-shaped defect DF is observed based on the observation result of the dark-field observation in the second optical system 20, the determination unit 31 determines that the defect DF is the pin hole HL based on the observation result of the bright-field observation in the first optical system 10 in the case in which the central luminance of the defect is equal to or smaller than the threshold value, and determines that the defect DF is the recess in the case in which the central luminance of the defect exceeds the threshold value.

In the case in which the classification of the defect DF is a foreign matter, the determination unit 31 determines the size of the foreign matter based on the observation result of the bright-field observation in the first optical system 10. In the case in which the classification of the defect is the pin hole HL or the recess, the determination unit 31 determines the size of the pin hole HL or the recess based on the observation result of the bright-field observation in the first optical system 10 and the observation result of the dark-field observation in the second optical system 20.

Next, the inspection method will be described. In step S12 of performing the dark-field observation in the inspection method of the present embodiment, the second optical system 20 uses the off-axis illumination in which the optical axis of the second light L2 is inclined with respect to the first surface 51 in the plurality of directions. In step S12 of performing the dark-field observation, the second optical system 20 may perform off-axis illumination along a plurality of optical paths provided at a plurality of positions annularly surrounding the periphery of the objective lens 13 that receives the second observation light R2.

In determining step S13, the classification of the defect DF is determined based on the observation result of the dark-field observation in the second optical system 20. Herein, the classification of the defect DF includes the pin hole HL and the recess. In determining step S13, the sizes of the pin hole HL and the recess may be determined based on the observation result of the bright-field observation in the first optical system 10 and the observation result of the dark-field observation in the second optical system 20.

In determining step S13, in the case in which the classification of the defect DF is a foreign matter, the size of the foreign matter is determined based on the observation result of the bright-field observation in the first optical system 10. In the case in which the classification of the defect DF is a pin hole and a recess, the sizes of the pin hole HL and the recess may be determined based on the observation result of the bright-field observation in the first optical system 10 and the observation result of the dark-field observation in the second optical system 20.

According to the present embodiment, the pin hole HL in the film 50 and the recess in the first surface 51 of the film 50 can be observed by the dark-field observation in the second optical system 20 with ring-shaped scattered light. In this case, the pin hole HL and the recess can be distinguished from each other by combining the bright-field observation in the first optical system 10. The inspection apparatus 2 of the present embodiment can accurately measure the sizes of the pin hole HL and the recess in the first surface 51.

### Third Embodiment

Next, an inspection apparatus and an inspection method according to a third embodiment will be described. The inspection apparatus 1 of the first embodiment is premised on the determination made by the determination unit 31 as to whether the defect DF on the film 50 is the defect DF above the first surface 51 of the film 50 or the defect DF below the first surface 51 based on the combination of the observation result of the bright-field observation in the first optical system 10 and the observation result of the dark-field observation in the second optical system 20. In the present embodiment, the size of the defect DF is determined without being premised on such a determination.

Specifically, the inspection apparatus includes the first optical system 10, the second optical system 20, and the determination unit 31. The first optical system 10 illuminates the film 50 with the first light L1 transmitted through the film 50 and receives the first observation light R1 from the first surface 51 side of the film 50. The second optical system illuminates the film 50 from the first surface 51 side with the second light L2 reflected from the first surface 51 of the film 50 and receives the second observation light R2 from the first surface 51 side. The second optical system 20 uses the off-axis illumination in which the optical axis of the second light L2 is inclined with respect to the first surface 51 in the plurality of directions. The second optical system 20 may perform off-axis illumination along a plurality of optical paths provided at a plurality of positions annularly surrounding the periphery of the objective lens 13 that receives the second observation light R2.

The determination unit 31 determines the size in the first surface 51 of a depressed defect formed in the film 50 based on the combination of an observation result of the bright-field observation in the first optical system 10 and an observation result of the dark-field observation in the second optical system 20. The depressed defect includes the pin hole HL and the recess. In a case in which the classification (type) of the defect is a foreign matter, the determination unit 31 may determine the size of the foreign matter based on the observation result of the bright-field observation in the first optical system 10, and in a case in which the classification (type) of the defect is a depressed defect, may determine the size of the depressed defect based on the observation result of the bright-field observation in the first optical system 10 and the observation result of the dark-field observation in the second optical system 20. Even with such a configuration, the size of the depressed defect in the first surface 51 can be accurately measured. The determination unit 31 may determine the classification of the depressed defect formed in the film 50 based on the combination of the observation result of the bright-field observation in the first optical system 10 and the observation result of the dark-field observation in the second optical system 20. In other words, the determination unit 31 detects the depressed defect including at least either of the pin hole HL and the recess in the case in which the ring-shaped defect DF is observed based on the observation result of the dark-field observation in the second optical system 20, and determines that the depressed defect is the pin hole HL in the case in which the central luminance of the defect is equal to or smaller than the threshold value and determines that the depressed defect is the recess in the case in which the central luminance of the defect exceeds the threshold value based on the observation result of the bright-field observation in the first optical system 10.

The inspection method of the present embodiment includes step S11 of performing the bright-field observation, step S12 of performing the dark-field observation, and determining step S13. In step S11 of performing the bright-field observation, the film 50 is illuminated with the first light L1 transmitted through the film 50, and the first observation light R1 is received from the first surface 51 side of the film 50. In step S12 of performing the dark-field observation, the film 50 is illuminated from the first surface 51 side with the second light L2 reflected from the first surface 51 of the film 50, and the second observation light R2 is received from the first surface 51 side. The second optical system 20 uses the off-axis illumination in which the optical axis of the second light L2 is inclined with respect to the first surface 51 in the plurality of directions. The second optical system 20 performs the off-axis illumination along a plurality of optical paths provided at a plurality of positions annularly surrounding the periphery of the objective lens 13 that receives the second observation light R2.

In determining step S13, the size in the first surface 51 of the depressed defect formed in the film 50 is determined by the determination unit 31 based on the combination of the observation result of the bright-field observation in the first optical system 10 and the observation result of the dark-field observation in the second optical system 20. In the determining step, in the case in which the classification of the defect DF is a foreign matter, the size of the foreign matter is determined based on the observation result of the bright-field observation in the first optical system 10. In the case in which the classification of the defect DF is a depressed defect, the size of the depressed defect is determined based on the observation result of the bright-field observation in the first optical system 10 and the observation result of the dark-field observation in the second optical system 20. In determining step S13, the classification of the depressed defect formed in the film 50 may be determined based on the combination of the observation result of the bright-field observation in the first optical system 10 and the observation result of the dark-field observation in the second optical system 20.

Although the embodiments of the present disclosure have been described above, the present disclosure involves appropriate modifications not impairing the object and advantages thereof and is not limited by the above-described embodiments. Appropriate omission and combination of the respective components of the first to third embodiments also fall within the technical idea of the present disclosure. In addition, the following components also fall within the technical idea of the embodiments.

### (Supplementary Note 1)

An inspection method comprising the steps of:
performing bright-field observation in a first optical system configured to illuminate a film with first light transmitted through the film and receive first observation light from a first surface side of the film;
performing dark-field observation in a second optical system configured to illuminate the film from the first surface side with second light reflected from the first surface of the film and receive second observation light from the first surface side; and
determining in a determination unit whether a position of a defect of the film, when the first surface side in a thickness direction of the film is located above and a second surface side on an opposite side of the first surface is located below, is the defect above the first surface of the film or the defect below the first surface based on a combination of an observation result of the bright-field observation in the first optical system and an observation result of the dark-field observation in the second optical system.

### (Supplementary Note 2)

The inspection method according to Supplementary note 1, in which in the determining step,
the defect is determined as the defect above the first surface in a case in which the defect is detected both in the observation result in the first optical system and the observation result in the second optical system, and
the defect is determined as the defect below the first surface in a case in which the defect is detected in the observation result in the first optical system and in which the defect is not detected in the observation result in the second optical system.

### (Supplementary Note 3)

The inspection method according to Supplementary note 1, in which in the determining step,
the defect is determined as the defect due to a foreign matter on the first surface in a case in which the defect is detected both in the observation result in the first optical system and the observation result in the second optical system, and
the defect is determined as the defect due to a foreign matter on the second surface in a case in which the defect is detected in the observation result in the first optical system and in which the defect is not detected in the observation result in the second optical system.

### (Supplementary Note 4)

The inspection method according to Supplementary note 1, in which
in the step of performing the bright-field observation,
the first optical system makes an optical axis of the first light perpendicular to the first surface,
in the step of performing the dark-field observation,
the second optical system uses off-axis illumination in which an optical axis of the second light is inclined with respect to the first surface, and
an objective lens configured to receive the second observation light in the second optical system is common to the objective lens configured to receive the first observation light in the first optical system.

### (Supplementary Note 5)

The inspection method according to Supplementary note 4, in which
in the step of performing the bright-field observation, the first optical system illuminates the film from the first surface side with the first light, and
the objective lens focuses the first light in the first optical system on the film.

### (Supplementary Note 6)

The inspection method according to Supplementary note 1, in which in the step of performing the bright-field observation,
the first light in the first optical system includes a wavelength equal to or larger than 600 nm and equal to or smaller than 750 nm,
in the step of performing the dark-field observation,
the second light in the second optical system includes a wavelength equal to or larger than 350 nm and equal to or smaller than 550 nm, and
an angle of incidence of the second light in the second optical system includes an angle equal to or larger than 60° and equal to or smaller than 85°.

### (Supplementary Mote 7)

The inspection method according to Supplementary note 1, in which in the determining step,
a shape including a size of the defect is determined based on the observation result in the first optical system, and
a position of the defect in the thickness direction of the film is determined in a case in which the shape of the defect is a predetermined shape.

### (Supplementary Mote 8)

The inspection method according to Supplementary note 1, further comprising the steps of:
performing, in the second optical system, changed dark-field observation in which at least any of polarized state changing of changing a polarized state of the second light to a polarized state in which an amount of light transmitted through the film increases, wavelength changing of changing a wavelength of the second light to a wavelength at which the amount of light transmitted through the film increases, and angle-of-incidence changing of changing an angle of incidence of the second light to an angle of incidence at which the amount of light transmitted through the film increases is performed; and
acquiring height information about the defect from a result of the changed dark-field observation and classifying the defect.

### (Supplementary Note 9)

The inspection method according to Supplementary note 4, in which the film includes a pellicle attached to a photomask.

### (Supplementary Note 10)

The inspection method according to Supplementary note 9, in which the objective lens has a focal depth smaller than a distance between the photomask and the pellicle.

### (Supplementary Note 11)

The inspection method according to Supplementary note 5, in which the film includes a pellicle attached to a photomask,
the inspection method further comprising the step of, in the first optical system, observing a patterned surface formed on the photomask.

### (Supplementary Mote 12)

The inspection method according to Supplementary note 9, in which the photomask includes a photomask for EUV exposure.

### (Supplementary Note 13)

The inspection method according to Supplementary note 1, in which
in the step of performing the dark-field observation,
the second optical system uses off-axis illumination in which an optical axis of the second light is inclined with respect to the first surface in a plurality of directions,
in the determining step,
a classification of the defect is determined based on the observation result of the dark-field observation in the second optical system, and
the classification of the defect includes a pin hole.

### (Supplementary Note 14)

The inspection method according to Supplementary note 13, in which in the step of performing the dark-field observation,
the second optical system performs off-axis illumination along a plurality of optical paths provided at a plurality of positions annularly surrounding a periphery of an objective lens configured to receive the second observation light.

### (Supplementary Note 15)

The inspection method according to Supplementary note 13, in which in the determining step,
a size of the pin hole is determined based on the observation result of the bright-field observation in the first optical system and the observation result of the dark-field observation in the second optical system.

### (Supplementary Note 16)

The inspection method according to Supplementary note 15, in which in the determining step,
in a case in which the classification of the defect is a foreign matter, the size of the foreign matter is determined based on the observation result of the bright-field observation in the first optical system, and
in a case in which the classification of the defect is the pin hole, the size of the pin hole is determined based on the observation result of the bright-field observation in the first optical system and the observation result of the dark-field observation in the second optical system.

### (Supplementary Note A1)

An inspection apparatus comprising:
a first optical system configured to illuminate a film with first light transmitted through the film and receive first observation light from a first surface side of the film;
a second optical system configured to illuminate the film from the first surface side with second light reflected from the first surface of the film and receive second observation light from the first surface side; and
a determination unit configured to determine a size in the first surface of a depressed defect including at least either of a pin hole and a recess formed in the film based on a combination of an observation result of bright-field observation in the first optical system and an observation result of dark-field observation in the second optical system,
in which the second optical system uses off-axis illumination in which an optical axis of the second light is inclined with respect to the first surface in a plurality of directions.

### (Supplementary Note A2)

The inspection apparatus according to Supplementary note A1, in which the second optical system performs off-axis illumination along a plurality of optical paths provided at a plurality of positions annularly surrounding a periphery of an objective lens configured to receive the second observation light.

### (Supplementary Note A3)

The inspection apparatus according to Supplementary note A1, in which the determination unit
classifies whether a classification of the defect is a foreign matter or the depressed defect based on the observation result of the dark-field observation in the second optical system,
in a case in which the classification of the defect is the foreign matter, determines a size of the foreign matter based on the observation result of the bright-field observation in the first optical system, and
in a case in which the classification of the defect is the depressed defect, determines the size of the depressed defect based on the observation result of the bright-field observation in the first optical system and the observation result of the dark-field observation in the second optical system.

### (Supplementary Note B1)

An inspection method comprising the steps of:
performing bright-field observation in a first optical system configured to illuminate a film with first light transmitted through the film and receive first observation light from a first surface side of the film;
performing dark-field observation in a second optical system configured to illuminate the film from the first surface side with second light reflected from the first surface of the film and receive second observation light from the first surface side; and
determining in a determination unit a size in the first surface of a depressed defect including at least either of a pin hole and a recess formed in the film based on a combination of an observation result of the bright-field observation in the first optical system and an observation result of the dark-field observation in the second optical system, in which
in the step of performing the dark-field observation,
the second optical system uses off-axis illumination in which an optical axis of the second light is inclined with respect to the first surface in a plurality of directions.

### (Supplementary Note B2)

The inspection method according to Supplementary note B1, in which in the step of performing the dark-field observation,
the second optical system performs off-axis illumination along a plurality of optical paths provided at a plurality of positions annularly surrounding a periphery of an objective lens configured to receive the second observation light.

### (Supplementary Note B3)

The inspection method according to Supplementary note B1, in which in the determining step,
whether a classification of the defect is a foreign matter or the depressed defect is classified based on the observation result of the dark-field observation in the second optical system,
in a case in which the classification of the defect is the foreign matter, a size of the foreign matter is determined based on the observation result of the bright-field observation in the first optical system, and
in a case in which the classification of the defect is the depressed defect, the size of the depressed defect is determined based on the observation result of the bright-field observation in the first optical system and the observation result of the dark-field observation in the second optical system.

### (Supplementary Note C1)

An inspection apparatus comprising:
a first optical system configured to illuminate a film with first light transmitted through the film and receive first observation light from a first surface side of the film;
a second optical system configured to illuminate the film from the first surface side with second light reflected from the first surface of the film and receive second observation light from the first surface side; and
a determination unit configured to determine detection of a depressed defect including at least either of a pin hole and a recess formed in the film based on an observation result of dark-field observation in the second optical system, and classify the depressed defect as either of the pin hole and the recess based on an observation result of bright-field observation in the first optical system,
in which the second optical system uses off-axis illumination in which an optical axis of the second light is inclined with respect to the first surface in a plurality of directions.

### (Supplementary Note C2)

The inspection apparatus according to Supplementary note C1, in which the second optical system performs off-axis illumination along a plurality of optical paths provided at a plurality of positions annularly surrounding a periphery of an objective lens configured to receive the second observation light.

### (Supplementary Note D1)

An inspection method comprising the steps of:
performing bright-field observation in a first optical system configured to illuminate a film with first light transmitted through the film and receive first observation light from a first surface side of the film;
performing dark-field observation in a second optical system configured to illuminate the film from the first surface side with second light reflected from the first surface of the film and receive second observation light from the first surface side; and
determining detection of a depressed defect including at least either of a pin hole and a recess formed in the film based on an observation result of the bright-field observation in the first optical system, and classifying the depressed defect as either of the pin hole and the recess based on an observation result of the dark-field observation in the second optical system,
in which in the step of performing the dark-field observation,
the second optical system uses off-axis illumination in which an optical axis of the second light is inclined with respect to the first surface in a plurality of directions.

### (Supplementary Note D2)

The inspection method according to Supplementary note D1, in which in the step of performing the dark-field observation,
the second optical system performs off-axis illumination along a plurality of optical paths provided at a plurality of positions annularly surrounding a periphery of an objective lens configured to receive the second observation light.

The first to third embodiments can be combined as desirable by one of ordinary skill in the art.

### (Supplementary Note E1)

An inspection apparatus comprising:
a first optical system configured to illuminate a film with first light being transmitted through the film and receive first observation light from a first surface side of the film;
a second optical system configured to illuminate the film from the first surface side with second light being reflected from the first surface of the film and receive second observation light from the first surface side; and
a determination unit configured to classify a defect of the film based on a combination of an observation result of bright-field observation in the first optical system and an observation result of dark-field observation in the second optical system,
wherein the second optical system uses off-axis illumination in which an optical axis of the second light is inclined with respect to the first surface in a plurality of directions;
   wherein the determination unit
classifies the defect either (i) the defect due to a foreign matter on the first surface, (ii) the defect due to a foreign matter on the second surface, or (iii) the depressed defect on the film.

### (Supplementary Note F1)

An inspection method comprising the steps of:
performing bright-field observation in a first optical system configured to illuminate a film with first light being transmitted through the film and receive first observation light from a first surface side of the film;
performing dark-field observation in a second optical system configured to illuminate the film from the first surface side with second light being reflected from the first surface of the film and receive second observation light from the first surface side, wherein the second optical system uses off-axis illumination in which an optical axis of the second light is inclined with respect to the first surface in a plurality of directions; and
classifying the defect of the film in a determination unit based on a combination of an observation result of the bright-field observation in the first optical system and an observation result of the dark-field observation in the second optical system,
in which in the determining step,
the defect of the film is classified as either (i) the defect due to a foreign matter on the first surface, (ii) the defect due to a foreign matter on the second surface, or (iii) the depressed defect on the film.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An inspection apparatus comprising:
a first optical system configured to illuminate a film with first light being transmitted through the film and receive first observation light from a first surface side of the film;
a second optical system configured to illuminate the film from the first surface side with second light being reflected from the first surface of the film and receive second observation light from the first surface side; and
a determination unit configured to determine whether a position of a defect of the film, when the first surface side in a thickness direction of the film is located above and a second surface side on an opposite side of the first surface is located below, is the defect above the first surface of the film or the defect below the first surface based on a combination of an observation result of bright-field observation in the first optical system and an observation result of dark-field observation in the second optical system.

2. The inspection apparatus according to claim 1, wherein the determination unit
determines that the defect is the defect above the first surface in a case in which the defect is detected both in the observation result in the first optical system and the observation result in the second optical system, and
determines that the defect is the defect below the first surface in a case in which the defect is detected in the observation result in the first optical system and in which the defect is not detected in the observation result in the second optical system.

3. An inspection apparatus comprising:
a first optical system configured to illuminate a film with first light transmitted through the film and receive first observation light from a first surface side of the film;
a second optical system configured to illuminate the film from the first surface side with second light reflected from the first surface of the film and receive second observation light from the first surface side; and
a determination unit configured to determine whether a position of a defect of the film based on a combination of an observation result of bright-field observation in the first optical system and an observation result of dark-field observation in the second optical system; and
wherein the determination unit determines that the defect is the defect due to a foreign matter on the first surface in a case in which the defect is detected both in the observation result in the first optical system and the observation result in the second optical system, and
determines that the defect is the defect due to a foreign matter on the second surface in a case in which the defect is detected in the observation result in the first optical system and in which the defect is not detected in the observation result in the second optical system.

4. The inspection apparatus according to claim 1, wherein
the first optical system makes an optical axis of the first light perpendicular to the first surface,
the second optical system uses off-axis illumination in which an optical axis of the second light is inclined with respect to the first surface, and
an objective lens configured to receive the second observation light in the second optical system is common to the objective lens configured to receive the first observation light in the first optical system.

5. The inspection apparatus according to claim 4, wherein
the first optical system illuminates the film from the first surface side with the first light, and
the objective lens focuses the first light in the first optical system on the film.

6. The inspection apparatus according to claim 1, wherein
the first light in the first optical system includes a wavelength equal to or larger than 600 nm and equal to or smaller than 750 nm,
the second light in the second optical system includes a wavelength equal to or larger than 350 nm and equal to or smaller than 550 nm, and
an angle of incidence of the second light in the second optical system includes an angle equal to or larger than 60° and equal to or smaller than 85°.

7. The inspection apparatus according to claim 1, wherein the determination unit
determines a shape including a size of the defect based on the observation result in the first optical system, and
determines a position of the defect in the thickness direction of the film in a case in which the shape of the defect is a predetermined shape.

8. The inspection apparatus according to claim 1, wherein
the second optical system performs changed dark-field observation in which at least any of polarized state changing of changing a polarized state of the second light to a polarized state in which an amount of light transmitted through the film increases, wavelength changing of changing a wavelength of the second light to a wavelength at which the amount of light transmitted through the film increases, and angle-of-incidence changing of changing an angle of incidence of the second light to an angle of incidence at which the amount of light transmitted through the film increases is performed, and
the determination unit acquires height information about the defect from a result of the changed dark-field observation and classifies the defect.

9. The inspection apparatus according to claim 4, wherein the film includes a pellicle attached to a photomask.

10. The inspection apparatus according to claim 9, wherein the objective lens has a focal depth smaller than a distance between the photomask and the pellicle.

11. The inspection apparatus according to claim 5, wherein
the film includes a pellicle attached to a photomask, and
the first optical system observes a patterned surface formed on the photomask.

12. The inspection apparatus according to claim 9, wherein the photomask includes a photomask for EUV exposure.

13. An inspection method comprising the steps of:
performing bright-field observation in a first optical system configured to illuminate a film with first light transmitted through the film and receive first observation light from a first surface side of the film;
performing dark-field observation in a second optical system configured to illuminate the film from the first surface side with second light reflected from the first surface of the film and receive second observation light from the first surface side; and
determining in a determination unit whether a position of a defect of the film, when the first surface side in a thickness direction of the film is located above and a second surface side on an opposite side of the first surface is located below, is the defect above the first surface of the film or the defect below the first surface based on a combination of an observation result of the bright-field observation in the first optical system and an observation result of the dark-field observation in the second optical system.

14. The inspection apparatus according to claim 1, wherein
the second optical system uses off-axis illumination in which an optical axis of the second light is inclined with respect to the first surface in a plurality of directions,
the determination unit determines a classification of the defect based on the observation result of the dark-field observation in the second optical system, and
the classification of the defect includes a pin hole.

15. The inspection apparatus according to claim 14, wherein the second optical system performs off-axis illumination along a plurality of optical paths provided at a plurality of positions annularly surrounding a periphery of an objective lens configured to receive the second observation light.

16. The inspection apparatus according to claim 14, wherein the determination unit determines a size of the pin hole based on the observation result of the bright-field observation in the first optical system and the observation result of the dark-field observation in the second optical system.

17. The inspection apparatus according to claim 16, wherein the determination unit
in a case in which the classification of the defect is a foreign matter, determines a size of the foreign matter based on the observation result of the bright-field observation in the first optical system, and
in a case in which the classification of the defect is the pin hole, determines the size of the pin hole based on the observation result of the bright-field observation in the first optical system and the observation result of the dark-field observation in the second optical system.

18. An inspection method comprising the steps of:
performing bright-field observation in a first optical system configured to illuminate a film with first light transmitted through the film and receive first observation light from a first surface side of the film;
performing dark-field observation in a second optical system configured to illuminate the film from the first surface side with second light reflected from the first surface of the film and receive second observation light from the first surface side; and
determining in a determination unit whether a position of a defect of the film based on a combination of an observation result of the bright-field observation in the first optical system and an observation result of the dark-field observation in the second optical system,
in which in the determining step,
the defect is determined as the defect due to a foreign matter on the first surface in a case in which the defect is detected both in the observation result in the first optical system and the observation result in the second optical system, and
the defect is determined as the defect due to a foreign matter on the second surface in a case in which the defect is detected in the observation result in the first optical system and in which the defect is not detected in the observation result in the second optical system.
